(19) United States
(12) Patent Application Publication
(10) Pub. No.: US 2025/0142666 A1
(43) Pub. Date: May 1, 2025

(54) METHODS AND DEVICES FOR SUPPORTING RECEIVING MULTICAST SERVICES IN AN INACTIVE STATE

(71) Applicant: ZTE CORPORATION, Shenzhen (CN)

(72) Inventors: Yang LI, Shenzhen (CN); Tao QI, Shenzhen (CN); Lin CHEN, Shenzhen (CN)

(73) Assignee: ZTE CORPORATION, Shenzhen (CN)

(21) Appl. No.: 18/989,014

(22) Filed: Dec. 20, 2024

Related U.S. Application Data
(63) Continuation of application No. PCT/CN2022/110938, filed on Aug. 8, 2022.

(51) Int. Cl. H04W 76/27; H04W 72/30

(52) U.S. Cl. CPC H04W 76/27; H04W 72/30

(57) ABSTRACT

The present disclosure relates to a method for supporting multicast reception for a user equipment, UE, in an RRC_INACTIVE state is disclosed. The method comprises receiving, by a distributed unit, DU, indication information from a central unit, CU, and providing, by the DU, configuration information to the CU. The present disclosure also relates to a method for supporting multicast reception for a user equipment, UE, in an RRC_INACTIVE state. The method comprises receiving, by a UE, a configuration about multicast reception in the RRC_INACTIVE state, and receiving, by the UE, multicast in the RRC_INACTIVE state.

### CROSS-REFERENCE TO RELATED PATENT APPLICATIONS

This application is a Continuation of PCT Application No. PCT/CN2022/110938, filed Aug. 8, 2022, incorporated herein by reference in its entirety.

### TECHNICAL FIELD

This document is directed generally to wireless communications, in particular to fifth generation (5G) wireless communications, more particularly to methods and apparatuses for supporting receiving multicast services in an inactive state.

### BACKGROUND

Multicast and Broadcast Services (MBS), which is considered to be one of the most prominent use cases of 5G New Radio (NR), provides reliable, low-latency, and resource-efficient transmission to multiple terminals that need to receive the same content. Its main usage scenarios are mostly concentrated in crowded areas, such as concerts, sport stadiums, and racing tracks. On the one hand, there may be situations where the video needs to be synchronized to the terminal, on the other hand, there may be situations where multiple viewing angles are required. In addition, a large number of users in the same cell watch Virtual Reality (VR) live broadcasts at the same time, push the epidemic situation and disaster situation in a certain area through applications (APP) or TV.

### SUMMARY

One open task is how to deal with the problem of cell congestion. Considering that the number of UEs connected to the cell and the volume of services carried by the cell are limited, the resulted congestion of the cell can lead to reject or reduce the transmission of other services or UEs.

In 5G NR, the UE has three RRC states, RRC_CONNECTED, RRC_IDLE, and RRC_INACTIVE, RRC_INACTIVE is a new state defined by 5G NR. When the UE enters the RRC_INACTIVE state, it will retain part of the context of the access network.

In the RRC_INACTIVE state, if there is data to be transmitted, it needs to transition to the RRC_CONNECTED state through the connection recovery process. The introducing of RRC_INACTIVE state not only saves energy but also maintains the delay of the control plane in control, i.e., the UE can quickly enter the RRC_CONNECTED state with a lower CP delay compared to RRC_IDLE.

One of the solutions to have or continue MBS multicast reception in cell congestion or power saving required scenarios, might be having state transition to the RRC_INACTIVE for some UEs who have applied MBS multicast. Such UE(s) can be transitioned from RRC_CONNECTED state to RRC_INACTIVE state, to receive or continue receiving the Multicast session.

In Rel-17 NR MBS, PTM configuration delivery methods were specified as follows:
i. For Multicast, dedicated signaling was used for Multicast in Rel-17 only;
ii. for Broadcast, only SC-PTM like signaling is used (for Broadcast reception in other SCell, dedicated signaling to delivery SIBx was used).

In Rel-18, the requirement of Multicast reception in RRC_INACTIVE was confirmed.

According to this disclosure, solutions are proposed on how to enable the UE to receive or continue receiving MBS services in the RRC_INACTIVE state.

This document relates to methods, systems, and devices for supporting receiving multicast services in an inactive state.

The present disclosure relates to a method for supporting multicast reception for a user equipment, UE, in an RRC_INACTIVE state, comprising: receiving, by a distributed unit, DU, indication information from a central unit, CU, and providing, by the DU, configuration information to the CU.

Various embodiments may preferably implement the following features:

Preferably or in some embodiments, the indication information from the CU to the DU is carried in a multicast context setup request and/or a multicast context modification request.

Preferably or in some embodiments, the indication information from the CU to the DU is carried in a broadcast context setup request and/or a broadcast context modification request.

Preferably or in some embodiments, the configuration information from the DU to the CU is carried in a multicast context setup response and/or a multicast context modification response.

Preferably or in some embodiments, the configuration information from the DU to the CU is carried in a broadcast context setup response and/or a broadcast context modification response.

Preferably or in some embodiments, the indication information from the CU to the DU indicates multicast service(s) is transmitted for the RRC_INACTIVE UE, and/or the DU maintains a point-to-multipoint, PTM, transmission available for multicast service(s) regardless of whether there is a UE in a RRC_CONNECTED connected state.

Preferably or in some embodiments, the indication information from the CU to the DU indicates that the DU configures the second set of PTM configuration for the multicast service(s) to be provided by a Multicast and Broadcast Service, MBS, Control Channel, MCCH, and/or the DU configures and provides the second set of PTM configuration for the multicast service(s) to be provided by MCCH.

Preferably or in some embodiments, the indication information from the CU to the DU indicates that the resources of both sets of PTM configurations for the same multicast service is the same, and/or the DU configures and provides the PTM configuration by the MCCH based on the current PTM configuration provided by dedicated signaling for the same multicast service(s), and/or the CU indicates the resources of two sets of PTM configurations for the same multicast are the same and provides the mapping relationship between the Radio Bearer, RB, index in MCCH and RB identity, ID, in dedicated signaling for the same multicast through dedicated signaling.

Preferably or in some embodiments, the configuration information from DU to CU indicates the resources of both sets of PTM configurations for the same multicast service are the same and/or the CU indicates the resources of two sets of PTM configurations for the same multicast are the same and provides the mapping relationship between the RB index in MCCH and RB ID in dedicated signaling for the same multicast through dedicated signaling.

Preferably or in some embodiments, the indication information from the CU to the DU indicates that the multicast reception area setting about the multicast service(s) transmitted for the RRC_INACTIVE UE, particularly a Radio Access Network (RAN)-based notification area, RNA area, can be set as a multicast reception area, and/or the DU provides the PTM configuration for the multicast service(s) to all cells in the multicast reception area.

Preferably or in some embodiments, the information of multicast reception area includes at least one of:
a list of Cell id,
a list of Cell frequency,
a multicast service id, or
whether the PTM configuration is the same or not.

Preferably or in some embodiments, the indication information from the CU to the DU indicates to request the cell information related to multicast reception for the RRC_INACTIVE UE, and/or the DU provides cell information related to multicast reception to CU.

Preferably or in some embodiments, the indication information from the CU to the DU carries collected cell information related to multicast reception to the DU.

Preferably or in some embodiments, the cell information includes at least one of:
a Cell ID,
a Cell frequency,
a multicast service ID transmitted in this cell,
a PTM configuration for multicast transmitted in this cell,
whether to support transmitting multicast to the UE in the RRC_INACTIVE state or not,
whether to deliver the PTM configuration for multicast by MCCH or not, or
whether the cell is congested or not.

The present disclosure further relates to a network node supporting multicast reception for a user equipment, UE, in an RRC_INACTIVE state comprising a processor configured to:
receive indication information from a central unit, CU, and
provide configuration information to the CU.

Various embodiments may preferably implement the following features:

Preferably or in some embodiments, the network node is a distributed unit, DU.

Preferably or in some embodiments, the indication information from the CU to the network node is carried in a multicast context setup request and/or a multicast context modification request.

Preferably or in some embodiments, the indication information from the CU to the network node is carried in a broadcast context setup request and/or a broadcast context modification request.

Preferably or in some embodiments, the configuration information from the network node to the CU is carried in a multicast context setup response and/or a multicast context modification response.

Preferably or in some embodiments, the configuration information from the network node to the CU is carried in a broadcast context setup response or a broadcast context modification response.

Preferably or in some embodiments, the indication information from the CU to the network node indicates multicast service(s) is transmitted for the RRC_INACTIVE UE, and/or the processor of the network node is configured to keep a point-to-multipoint, PTM, transmission available for multicast service(s) regardless of whether there is a UE in an RRC_CONNECTED state.

Preferably or in some embodiments, the indication information from the CU to the network node indicates that the processor of the network node is configured to configure the second set of PTM configuration for the multicast service(s) to be provided by a Multicast and Broadcast Service, MBS, control channel, MCCH, and/or the processor of the network node is configured to configure and provide the second set of PTM configuration for the multicast service(s) to be provided by MCCH.

Preferably or in some embodiments, the indication information from the CU to the network node indicates that the resources of both sets of PTM configurations for the same multicast service is the same, and/or the processor of the network node is configured to configure and provide the PTM configuration by the MCCH based on the current PTM configuration provided by dedicated signaling for the same multicast service(s), and/or the CU is configured to indicate the resources of two sets of PTM configurations for the same multicast are the same and to provide the mapping relationship between the RB index in MCCH and RB ID in dedicated signaling for the same multicast through dedicated signaling.

Preferably or in some embodiments, the configuration information from the network node to the CU indicates the resources of both sets of PTM configurations for the same multicast service are the same and/or the CU is configured to indicate the resources of two sets of PTM configurations for the same multicast are the same and provides the mapping relationship between the Radio Bearer, RB, index in MCCH and RB ID in dedicated signaling for the same multicast through dedicated signaling.

Preferably or in some embodiments, the indication information from the CU to the network node indicates that the multicast reception area setting about the multicast service(s) transmitted for the RRC_INACTIVE UE, particularly a RAN-based notification area, RNA area, can be set as a multicast reception area, and/or the processor of the network node is configured to provide the PTM configuration for the multicast service(s) to all cells in the multicast reception area.

Preferably or in some embodiments, the information of multicast reception area includes at least one of:
a list of Cell id,
a list of Cell frequency,
a multicast service id, or
whether the PTM configuration is the same or not.

Preferably or in some embodiments, the indication information from the CU to the network node indicates to request the cell information related to multicast reception for the RRC_INACTIVE UE, and/or the processor of the network node is configured to provide cell information related to multicast reception to CU.

Preferably or in some embodiments, the indication information from the CU to the network node carries collected cell information related to multicast reception to the network node.

Preferably or in some embodiments, the cell information includes at least one of:
a Cell ID,
a Cell frequency,
a multicast service ID transmitted in this cell,
a PTM configuration for multicast transmitted in this cell,
whether to support transmitting multicast to the UE in the RRC_INACTIVE state or not,
whether to deliver the PTM configuration for multicast by MCCH or not, or
whether the cell is congested or not.

The present disclosure further relates to a method for supporting multicast reception for a user equipment, UE, in an RRC_INACTIVE state, the method comprising:
receiving, by a UE, a configuration about multicast reception in the RRC_INACTIVE state, and
receiving, by the UE, multicast in the RRC_INACTIVE state.

Various embodiments may preferably implement the following features:

Preferably or in some embodiments, the configuration is carried in a Radio Resource Control, RRC, Reconfiguration and/or a RRC Release and/or a Multicast and Broadcast Service, MBS, Control Channel, MCCH.

Preferably or in some embodiments, the configuration includes an indication information indicating point-to-multipoint, PTM, configuration is provided by a Multicast and Broadcast Service, MBS, control channel, MCCH, for multicast transmitted in the RRC_INACTIVE state.

Preferably or in some embodiments, the configuration indicates the resources of two PTM configurations for the same multicast are the same, and carries the mapping relationship between the RB index in MCCH and RB ID in dedicated signaling for the same multicast, and/or the UE modifies the MRB ID according to the mapping relationship, and/or the UE receives multicast with the modified MRB.

Preferably or in some embodiments, the configuration carries a list of neighbor cell information about the multicast reception in the RRC_INACTIVE state.

Preferably or in some embodiments, the neighbor cell information includes at least one of:
a Cell ID,
a Cell frequency which is providing MBS multicast services, particularly cell defining SSB, CD-SSB,
whether to support transmitting multicast to UE in the RRC_INACTIVE state or not,
whether to deliver the PTM configuration for multicast by MCCH or not,
whether the PTM configuration for the same multicast is the same with the current cell or not, or
whether the cell is congested or not.

Preferably or in some embodiments, the UE applies the normal cell reselection rules with at least one of the following modifications:
the UE which is receiving or interested to receive MBS service(s) while camping on the frequency providing these MBS service(s) is allowed to make this frequency highest priority,
the UE considers the frequency providing the same PTM configuration about the multicast service(s) which is receiving by UE to be the highest priority,
the UE considers the frequency which is not congested to be the highest priority, or
when the MBS multicast service(s) which the UE is interested in are no longer available, particularly after the end of the session, or the UE is no longer interested in receiving the multicast service(s), the UE no longer prioritizes the frequency providing these multicast service(s).

Preferably or in some embodiments, the neighbor cell information shows PTM configurations in a last serving cell and a re-selected cell are the same, and/or the UE receives multicast using a PTM configuration which is obtained from a last serving cell after cell reselection.

Preferably or in some embodiments, the neighbor cell information shows PTM configurations in the re-selected cell is delivered by MCCH, and/or the UE monitors the MCCH to obtain a PTM configuration and its update after cell reselection.

Preferably or in some embodiments, the neighbor cell information shows no congestion and/or no support of MBS service transmission in RRC_INAVTIVE and/or a PTM configuration is not delivered by MCCH in the re-selected cell, and/or the UE triggers a RRC resume procedure after cell reselection.

Preferably or in some embodiments, when there is no information about a re-selected cell, the method further comprises:
the UE monitoring MCCH to obtain PTM configuration, and, if cannot obtain PTM configuration, the UE triggering the RRC resume procedure, or
the UE triggering a RRC resume procedure to obtain PTM configuration.

Preferably or in some embodiments, multicast for UEs in an RRC_INACTIVE state further comprises at least one of:
a resumeCause is used for the request of a multicast configuration update, which is carried in an RRC Resume Request,
a resumeCause is used for the request of a multicast service request, which is carried in an RRC Resume Request,
a new access category is added for the request of multicast configuration update/multicast service request, which has a higher priority, and the related barring factor is particularly configured to always allow access,
always skipping a bar checking process and accessing directly, particularly by reusing an access category, or
skipping a unified access control, UAC, process and accessing directly.

The present disclosure further relates to a user equipment, UE, supporting multicast reception in an RRC_INACTIVE state, the UE comprising a processor configured to:
receive a configuration about multicast reception in the RRC_INACTIVE state, and
receive multicast in the RRC_INACTIVE state.

Preferably or in some embodiments, the configuration is carried in a Radio Resource Control, RRC, Reconfiguration and/or a RRC Release and/or a MBS Control Channel, MCCH.

Preferably or in some embodiments, the configuration includes an indication information indicating point-to-multipoint, PTM, configuration is provided by a MBS Control Channel, MCCH, for multicast transmitted in the RRC_INACTIVE state.

Preferably or in some embodiments, the configuration indicates the resources of two PTM configurations for the same multicast are the same, and carries the mapping relationship between the Radio Bearer, RB, index in MCCH and RB ID in dedicated signaling for the same multicast, and/or the processor of the UE is configured to modify the MRB ID according to the mapping relationship, and/or the processor of the UE is configured to receive multicast with the modified MRB.

Preferably or in some embodiments, the configuration carries a list of neighbor cell information about the multicast reception in the RRC_INACTIVE state.

Preferably or in some embodiments, the neighbor cell information includes at least one of:
a Cell ID,
a Cell frequency which is providing MBS multicast services, particularly cell defining SSB, CD-SSB,
whether to support transmitting multicast to UE in the RRC_INACTIVE state or not,
whether to deliver the PTM configuration for multicast by MCCH or not,
whether the PTM configuration for the same multicast is the same with the current cell or not, or
whether the cell is congested or not.

Preferably or in some embodiments, the processor of the UE is configured to apply the normal cell reselection rules with at least one of the following modifications:
the processor of the UE which is receiving or interested to receive MBS service(s) while camping on the frequency providing these MBS service(s) is configured to be allowed to make this frequency highest priority,
the processor of the UE is configured to consider the frequency providing the same PTM configuration about the multicast service(s) which is receiving by UE to be the highest priority,
the processor of the UE is configured to consider the frequency which is not congested to be the highest priority, or
when the MBS multicast service(s) which the UE is interested in are no longer available, particularly after the end of the session, or the UE is no longer interested in receiving the multicast service(s), the processor of the UE is configured to no longer prioritize the frequency providing these multicast service(s).

Preferably or in some embodiments, the neighbor cell information shows PTM configurations in a last serving cell and a re-selected cell are the same, and/or wherein the processor of the UE is configured to receive multicast using a PTM configuration which is obtained from a last serving cell after cell reselection.

Preferably or in some embodiments, the neighbor cell information shows PTM configurations in the re-selected cell is delivered by MCCH, and/or the processor of the UE is configured to monitor the MCCH to obtain a PTM configuration and its update after cell reselection.

Preferably or in some embodiments, the neighbor cell information shows no congestion and/or no support of MBS service transmission in the RRC_INACTIVE state and/or a PTM configuration is not delivered by MCCH in the re-selected cell, and/or the processor of the UE is configured to trigger a RRC resume procedure after cell reselection.

Preferably or in some embodiments, when there is no information about a re-selected cell, the processor of the UE is configured to:
monitor MCCH to obtain PTM configuration, and, if cannot obtain PTM configuration, trigger the RRC resume procedure, or
trigger a RRC resume procedure to obtain PTM configuration.

Preferably or in some embodiments, multicast for UEs in the RRC_INACTIVE state further comprises at least one of:
a resumeCause is used for the request of a multicast configuration update, which is carried in an RRC Resume Request,
a resumeCause is used for the request of a multicast service request, which is carried in an RRC Resume Request,
a new access category is added for the request of multicast configuration update/multicast service request, which has a higher priority, and the related barring factor is particularly configured to always allow access,
always skipping a bar checking process and accessing directly, particularly by reusing an access category, or
skipping a unified access control, UAC, process and accessing directly.

The present disclosure relates to a computer program product comprising a computer-readable program medium code stored thereupon, the code, when executed by a processor, causing the processor to implement a wireless communication method recited in any one of the foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows an example of a schematic diagram of a wireless terminal according to an embodiment of the present disclosure.

FIG. 2 shows an example of a schematic diagram of a wireless network node according to an embodiment of the present disclosure.

FIGS. 3 and 4 show flowcharts of methods according to some embodiments of the present disclosure.

### DETAILED DESCRIPTION

In an embodiment, a network node may refer to a distributed unit, DU. A DU may also be referred to as a gNB-DU. A network node may also refer to a central unit, CU. A CU may also be referred to as a gNB-CU.

UE denotes a user equipment. A UE may also be referred to as one example of a node.

F1, Uu and Xn refer to respective interfaces.

TMGI denotes a temporary mobile group entity.

MCCH denotes an MBS (Multicast and Broadcast Service) control channel.

MRB denotes an MBS Radio Bearer.

An RRC_INACTIVE state may refer to an inactive state of a UE. An RRC_CONNECTED state may refer to a connected state of a UE. RRC denotes Radio Resource Control.

### Aspect 1: F1 Signaling

### Support Multicast Reception for RRC_INACTIVE UEs

In a legacy configuration method, a gNB-DU (gNB=next generation nodeB, i.e., a base station; gNB-distributed unit) may stop PTM transmission (point-to-multipoint transmission) or switch to PTP transmission (point-to-point transmission) for certain multicast service(s) due to the state transition of UE(s) which is receiving the multicast service(s).

In order to avoid the gNB-DU performing the same operation for the multicast service(s) which is/are to be received for UEs in RRC_INACTIVE, an indication information is carried in F1 signaling from CU to DU to indicate that PTM transmission of the multicast service is reserved regardless of UE(s) status.

### In One Embodiment

The indication information is carried in a multicast context setup request to indicate which multicast service(s) continue to be received by UE(s) in RRC_INACTIVE. When the DU receives the indication information, the DU will keep the PTM transmission available for the marked multicast service(s) regardless of UE(s) status.

### Support PTM Configuration Delivered by a MCCH (MBS Control Channel) for RRC_INACTIVE UEs

To support the modification and update of the PTM configuration for an RRC_INACTIVE UE, it is a possibility to deliver a second set of PTM configuration for multicast service(s) by MCCH.

In order to support the delivery of PTM configuration for multicast service(s) by MCCH, an indication information is carried in F1 signaling from CU to DU to indicate that PTM configuration is delivered by MCCH which is configured for multicast reception for RRC_INACTIVE UE(s).

### In One Embodiment

The indication information is carried in a multicast context setup request to indicate the PTM configuration of the multicast service transmitted for UEs in RRC_INACTIVE is delivered through MCCH. When the DU receives the indication information, the DU will generate a second set of PTM configuration delivered through MCCH for such multicast service(s).

### In One Embodiment

The indication information is carried in a multicast broadcast context setup request to indicate the PTM configuration of the multicast service transmitted for UEs in RRC_INACTIVE is delivered through MCCH. When the DU receives the indication information, the DU will generate a set of PTM configuration delivered through MCCH for such multicast service(s).

### In One Embodiment

CU indicates DU to configure PTM configuration for the multicast service(s) by triggering the broadcast MBS session setup procedure.

### The Configuration Delivered Through MCCH and Dedicated Signaling Use the Same Radio Resources for the Same Multicast

The configuration delivered through MCCH and dedicated signaling use the same radio resources for the same multicast, that is, for the same TMGI (temporary mobile group entity).

For the same service, the relationship between the configuration delivered by the MCCH and the configuration delivered by the dedicated signaling is that the resources are the same, and there is a mapping relationship between the RB index (MCCH) and the RB ID (dedicated signaling).

Therein, RB denotes a Radio Bearer.

When the UE successively receives two sets of PTM configurations from the dedicated signaling and the MCCH for the same TMGI (temporary mobile group entity), the configuration release and reestablish procedure will be performed according to the legacy method.

In order to ensure the continuity of multicast reception and reduce the data interruption caused by configuration switching, it is a solution to configure the same resources for two sets of PTM configurations for the same TMGI.

### In One Embodiment

The resources of both sets of PTM configurations for the same multicast service are the same as default.

After the CU indicates to the DU to configure a second set of PTM configuration for the multicast service(s), the DU will configure the PTM configuration based on the configuration delivered by the dedicated signaling and provide it to UE(s) by MCCH.

### In One Embodiment

To support that the configuration delivered through MCCH and dedicated signaling are related for the same TMGI, an indication information is carried in F1 signaling from CU to DU to indicating the resources of two sets of PTM configurations for the same TMGI are the same.

When the DU receives the indication information, the DU will generate a set of PTM configuration delivered through MCCH based on the corresponding PTM configuration which is delivered by dedicated signaling.

For the configuration of resources, the DU allocates the same resources for the configuration issued by the MCCH and the configuration issued by the corresponding dedicated signaling.

The indication information is carried in a multicast context setup request/multicast context modification request/broadcast context setup request/broadcast context modification request. Please note that “/”′ may refer to “and/or” throughout the present disclosure.

For the delivery method of mapping relationship between RB index and RB ID, CU provides the mapping relationship between two sets of PTM configurations for the same multicast service by dedicated signaling.

### In One Embodiment

The resources of both sets of PTM configurations for the same multicast service can be configured to the same by the DU.

The indication information is transmitted from DU to CU indicating the resources of both sets of PTM configurations for the same multicast service are the same.

CU provides the relationship between two sets of PTM configurations for the same multicast service by dedicated signaling.

The indication information is carried in a multicast context setup response/multicast context modification response/broadcast context setup response/broadcast context modification response.

### Support the Multicast Reception Area for RRC_INACTIVE UE

In order to reduce the frequency of UE state transition, the concept of multicast reception area is proposed.

The definition of multicast receiving area is described below.

The multicast receiving area can be defined for one service or for all services in the area.

### In One Embodiment (Per Service)

This area can be per service, that is, all cells in this area are transmitting this multicast service. When the UE moves in this area, it does not need to return to the RRC_CONNECTED state to request the multicast service. For this multicast service, the PTM configuration of the cells in this area can be the same or different.

### In One Embodiment (all Services)

This area can also contain all multicast services transmitted by the cells in the area in the inactive state, that is, each cell in the area transmits all the services which are already transmitted for the RRC_INACTIVE UE in the area. When the UE moves in this area, it does not need to return to the RRC_CONNECTED state to request the multicast service. For the same multicast service, the PTM configuration of the cells in this area can be the same or different.

### The Range of Multicast Reception Area is Described Below.

Which cells are included in the multicast reception area needs to be discussed. There are several options for it:
The cells in the same DU (intra-DU)
The cells in different DUs but the same CU (inter-DU but intra-CU)
The cells in different gNB (inter-gNB)

### In One Embodiment (Intra-DU)

The range of this area can be specified by gNB-CU or gNB-DU. For example, it is specified according to factors such as geographical location, UE distribution, and service distribution.

### In One Embodiment

The range of multicast reception area is specified by gNB-CU.

An indication information is transmitted from CU to DU to indicate that which cells are included in the area for which multicast service. E.g., RAN-based notification area (RNA area) can be set as multicast reception area.

The indication information is carried in a multicast context setup request/multicast context modification request/broadcast context setup request/broadcast context modification request.

The DU will provide the PTM configuration for this service to all cells in the area.

For the delivery method of multicast reception area setting, there are two options:

Opt1: DU provides the setting of multicast reception area by MCCH.

Opt2: CU provides the setting of multicast reception area by dedicated signaling. In one example: The range of multicast reception area is specified by gNB-DU.

For the delivery method of multicast reception area setting, there are two options:

Opt1: DU provides the setting of multicast reception area by MCCH.

Opt2: CU provides the setting of multicast reception area by dedicated signaling.

For opt2, the indication information from DU to CU indicates the multicast reception area setting for multicast service(s). E.g., RNA area can be set as multicast reception area.

The indication information is carried in a multicast context setup response/multicast context modification response/broadcast context setup response/broadcast context modification response.

### In One Embodiment

The information of multicast reception area includes:
The list of Cell ID
The list of Cell frequency
Multicast service id, or
whether PTM configuration is the same or not

### Support the Neighbor Cell Information for RRC_INACTIVE UE

For the UE in RRC_INACTIVE state which is receiving multicast, a key issue is how to support mobility. Some information about neighbor cells can be provided to the UE for better preforming cell reselection.

### Format of Neighbor Cells Information

### In One Embodiment (Per Service)

A cell list is associated with each multicast which is received in the RRC_INACTIVE state. The cells in the list are transmitting this multicast.

### In Another Embodiment (Per Cell)

For each neighbor cell, there is a multicast list which are received in this cell. The multicast services in the list are received in this cell.

The context of neighbor cell information options
Cell ID
Cell frequency which is providing MBS multicast services (e.g. cell defining SSB, CD-SSB)
Whether to support transmitting multicast to UE in the RRC_INACTIVE state or not
Whether to deliver the PTM configuration for multicast by MCCH or not
Whether the PTM configuration for the same multicast is the same with the current cell or not
Whether the cell is congested or not

Different neighbor cell information has different effects on the cell reselection procedure and behavior in the re-selected cell.

### The Range of Neighbor Cells for Multicast

For the generation of neighbor cell information, which cells need to be included is a key issue. There are several options about it.
The cells in the same DU (intra-DU)
The cells in different DUs but the same CU (inter-DU but intra-CU)
The cells in different gNB (inter-gNB)

### In One Embodiment (Intra-DU)

For the delivery method of neighbor cell information, there are two options:

Opt1: DU provides the neighbor cell information by MCCH.

Opt2: CU provides neighbor cell information by dedicated signaling.

For opt2, the indication information from DU to CU carries the cell information related to multicast reception. The cell information is carried in a multicast context setup response/multicast context modification response/broadcast context setup response/broadcast context modification response. CU provides collected cell information to UE(s) by dedicated signaling.

### In One Embodiment (Inter-DU but Intra-CU)

The indication information from CU to DU indicates to request the cell information related to multicast reception for RRC_INACTIVE UE.

The indication information is carried in a multicast context setup request/multicast context modification request/broadcast context setup request/broadcast context modification request.

The DU transmits cell information related to multicast reception to CU.

The cell information is carried in a multicast context setup response/multicast context modification response/broadcast context setup response/broadcast context modification response.

For the delivery method of neighbor cell information, there are two options:

Opt1: DU provides the neighbor cell information by MCCH.

Opt2: CU provides neighbor cell information by dedicated signaling.

For opt1, CU transmits collected cell information related to multicast reception to DU.

The collected cell information is carried in a multicast context setup request/multicast context modification request/multicast distribution setup response/broadcast context setup request/broadcast context modification request.

### In One Embodiment

The cell information includes:
Cell ID
Cell frequency
Multicast service ID transmitted in this cell
PTM configuration for multicast transmitted in this cell
Whether to support transmitting multicast to UE in the RRC_INACTIVE state or not
Whether to deliver the PTM configuration for multicast by MCCH or not
Whether the cell is congested or not

### Aspect 2: Uu Interface

### Support Multicast Reception for RRC_INACTIVE UES

To support the multicast reception for UEs in RRC_INACTIVE, an indication information is received from gNB, which indicates the multicast service(s) is transmitted in RRC_INACTIVE.

### In One Embodiment

The indication information is carried in an RRC Reconfiguration/RRC Release.

After receiving the indication information, the UE will receive the corresponding multicast service(s) in RRC_INACTIVE state.

### Support PTM Configuration Delivered by MCCH for RRC_INACTIVE UES

To support the modification and update of the PTM configuration for RRC_INACTIVE UE, it is a possibility to deliver a second set of PTM configuration for multicast service(s) by MCCH. An indication information is received from gNB, which indicates the PTM configuration is delivered by MCCH which is configured for multicast reception in RRC_INACTIVE.

### In One Embodiment

The indication information is carried in an RRC Reconfiguration/RRC Release.

After receiving the indication information, the UE will obtain the PTM configuration by MCCH.

### The Configuration Delivered Through MCCH and Dedicated Signaling Use the Same Radio Resources for the Same Multicast

The configuration delivered through MCCH and dedicated signaling use the same radio resources for the same multicast, that is, for the same TMGI (temporary mobile group entity).

When the UE successively receives two sets of PTM configurations from the dedicated signaling and the MCCH for the same TMGI, the configuration release and reestablish procedure will be performed according to the legacy method.

In order to ensure the continuity of multicast reception and reduce the data interruption caused by configuration switching, it is a solution to configure the same resources for two sets of PTM configurations for the same TMGI. The relationship between two sets of PTM configuration is delivered by gNB.

The multicast RB provided by the MCCH is assigned an index, and the corresponding mapping relationship with the RB ID of the dedicated signaling is indicated/carried in the configuration information. The resources in two sets of PTM configuration of the same TMGI are the same.

### In One Embodiment

An indication information is carried in an RRC Reconfiguration, which indicates the resources of two sets of PTM configurations for the same multicast transmitted in RRC_INACTIVE are the same, and provides the mapping relationship between the RB index in MCCH and RB ID in dedicated signaling for the same multicast transmitted in RRC_INACTIVE.

After receiving the indication information, the UE only needs to modify the MRB (MBS Radio Bearer) ID for MCCH configuration according to the mapping relationship and continue to receive multicast with the PTM configuration. And the UE will start monitoring the MCCH for the update of PTM configuration.

### In One Embodiment

An indication information is carried in an RRC Release, which indicates the resources of two sets of PTM configurations for the same multicast transmitted in RRC_INACTIVE are the same, and provides the mapping relationship between the RB index in MCCH and RB ID in dedicated signaling for the same multicast transmitted in RRC_INACTIVE.

After receiving the indication information, the UE will not suspend the corresponding PTM configuration but only modify the MRB ID for the MCCH configuration according to the mapping relationship and continue to receive multicast with the PTM configuration. And UE will start monitoring the MCCH for the update of PTM configuration.

### Support the Neighbor Cell Information for RRC_INACTIVE UE

For the UE in RRC_INACTIVE state which is receiving multicast, a key issue is how to support mobility. Some information about neighbor cells can be provided to the UE for better performing cell reselection.

### Format of Neighbor Cells Information is Described Below.

### In One Embodiment (Per Service)

A cell list is associated with each multicast which is received in the RRC_INACTIVE state. The cells in the list are transmitting this multicast.

### In Another Embodiment (Per Cell)

For each neighbor cell, there is a multicast list which are received in this cell. The multicast services in the list are received in this cell.

The context of neighbor cell information options includes:
Cell ID
Cell frequency which is providing MBS multicast services (e.g. CD-SSB)
Whether to support transmitting multicast to UE in the RRC_INACTIVE state or not
Whether to deliver the PTM configuration for multicast by MCCH or not
Whether the PTM configuration for the same multicast is the same with current cell or not
Whether the cell is congested or not

Different neighbor cell information has different effects on the cell reselection procedure and behavior in the re-selected cell.

### The Delivery Method of Neighbor Cell Information is Described Below.

### In One Embodiment

The RRC reconfiguration message carries neighbor cell information and its update.

UE obtains it to assist cell reselection.

### In One Embodiment

The RRC release message carries neighbor cell information.

UE obtains it to assist cell reselection.

### In One Embodiment

There are two options for MCCH carrying neighbor cell information:

Opt1: the neighbor cell information is always delivered by MCCH without any indication.

Opt2: there is an indication delivered by dedicated signaling, which indicates the UE to obtain neighbor cell information by MCCH.

For opt2, the indication information is carried in an RRC reconfiguration/RRC release.

The UE receives the neighbor cell information and its update from MCCH according to the indication information.

### The Cell Information Procedure is Described Below.

In order to ensure the continuity of multicast reception in RRC_INACTIVE as much as possible, the UE performs cell reselection according to the neighbor cell information.

### In One Embodiment

According to the list of neighbor cell information, for cell reselection, the UE which is receiving or interested to receive MBS service(s) while camping on the frequency providing these MBS service(s) is allowed to make this frequency highest priority.

### In One Embodiment

According to the list of neighbor cell information, for cell reselection, when the MBS multicast service(s) which the UE is interested in are no longer available (after the end of the session) or the UE is no longer interested in receiving the multicast service(s), the UE no longer prioritises the frequency providing these multicast service(s).

### In One Embodiment

According to the list of neighbor cell information, for cell reselection, the UE may consider the frequency providing the same PTM configuration about the multicast service(s) which is receiving by UE to be the highest priority.

### In One Embodiment

According to the list of neighbor cell information, for cell reselection, the UE may consider the frequency which is not congested to be the highest priority.

### UE Behavior in Re-Selected Cell is Described Below.

Different neighbor cell information will have different effects on UE behavior in re-selected cell.

### In One Embodiment (PTM Configuration is the Same)

The UE will continue to receive the MBS service(s) using the PTM configuration which is obtained from the last serving cell, if the neighbor cell information shows that the PTM configuration of MBS service(s) which is receiving or interested to receiving in the re-selected cell is the same with the last serving cell.

If the neighbor cell information also shows that the PTM configuration is obtained from MCCH in the re-selected cell, the UE will start to monitor MCCH for the update of PTM configuration.

Otherwise, if the neighbor cell information shows that the PTM configuration is not obtained from MCCH in the re-selected cell, when the UE cannot receive the MBS service(s) or the quality of reception is not good enough, it will trigger RRC Resume procedure for the update of PTM configuration.

### In One Embodiment (PTM Configuration is Different and is Delivered by MCCH)

The UE will start to monitor MCCH to obtain the PTM configuration at first when it finished the cell reselection procedure, if the neighbor cell information shows that the PTM configuration of MBS service(s) which is receiving or interested to receiving in the re-selected cell is the different with the last serving cell but can obtained from MCCH. And then receive the MBS service(s) with the obtained PTM configuration.

### In One Embodiment (No Congestion/not Support MBS Services Transmission in RRC_INACTIVE/PTM Configuration is not Delivered by MCCH)

The UE will trigger RRC resume procedure at first when it finished the cell reselection procedure, if the neighbor cell information shows that the re-selected cell is not congested/does not support MBS service(s) transmission in RRC_INACTIVE/does not deliver PTM configuration by MCCH.

If the re-selected cell is not congested, to ensure QoS of MBS Services, it is reasonable for the UE to resume RRC connection. But if the neighbor cell information also shows that the re-selected cell delivers PTM configuration by MCCH for MBS service(s) which UE is receiving or interested to receive, it is up to UE to decide whether to resume RRC connection for MBS service(s) reception or keep in the RRC_INACTIVE to obtain PTM configuration through MCCH.

If the re-selected cell does not support MBS service(s) transmission in RRC_INACTIVE, the UE can only resume RRC connection for MBS service(s) reception.

If the re-selected cell does not deliver PTM configuration by MCCH, the UE can only trigger RRC resume procedure for PTM configuration reception. But the PTM configuration is obtained from which dedicated signaling is up to network. If the network is congested, it can deliver PTM configuration through RRC release message. If the network is not congested, the UE will be allowed to resume RRC connection and obtain PTM configuration from RRC reconfiguration message.

### In One Embodiment (Others)

The UE behavior in the re-selected cell is associated with the delivery method of PTM configuration. If the network always delivers PTM configuration through dedicated signaling, UE will always trigger RRC resume procedure after cell reselection. If the network always delivers PTM configuration through MCCH, the UE will always start to monitor MCCH after cell reselection.

However, if the delivery method of PTM configuration is configurable, the UE will try to infer from the neighbor cell information whether the re-selected cell delivers PTM configuration through dedicated signaling or MCCH. If the delivery method can be inferred, the UE will perform the corresponding procedure.

But if the delivery method cannot be inferred from the neighbor cell information, it will be up to the UE to decide whether to monitor MCCH or trigger RRC resume procedure at first after finishing cell reselection.

There are two possibilities of UE behavior:
Opt1: The UE always triggers RRC resume procedure at first after cell reselection when it does not know the delivery method of PTM configuration.
Opt2: The UE always monitors MCCH at first after cell reselection when it does not know the delivery method of PTM configuration.

For Opt1, it may cause unnecessary RRC connection resumption, and congestion of the re-selected cell may become serious, such as when PTM configuration is delivered by MCCH in the re-selected cell.

For Opt2, it may cause longer interruption of MBS service(s) reception, such as when PTM configuration is delivered by dedicated signaling in the re-selected cell.

### Unified Access Control (UAC)

When the UE receives multicast service in the RRC_INACTIVE state, it may trigger the RRC connection resume procedure due to configuration requests, service requests, etc.

In order to ensure the continuity of multicast data reception as much as possible, it is necessary to do some enhancements in the RRC connection resume procedure, UAC procedure, etc.

Embodiments for RRC resume are described below.

### In One Embodiment

If the UE is receiving multicast services in RRC_INACTIVE, but for some reasons (such as poor reception quality), the RRC Resume procedure is triggered to request a configuration update.

To ensure that the request can be quickly identified and responded to, a resumeCause is used for the request of multicast configuration update, which is carried in an RRC Resume

### Request

According to the resumeCause, the gNB may response to the request by sending RRC Release which carries the PTM configuration about the multicast service(s) transmitted in RRC_INACTIVE.

### In One Embodiment

If the reason why the UE triggers the RRC Resume procedure is to request a multicast service, a resumeCause is used for the request of multicast service request, which is carried in an RRC Resume Request.

According to the resumeCause, gNB may respond to the request first.

Embodiments for Access Control are described below.

In order to improve the continuity of multicast reception as much as possible in RRC_INACTIVE, it should ensure that such requests are responded quickly. Giving higher priority to access control for such requests is a possible enhancement.

### In One Embodiment

A new access category is added, which has a higher priority, and the related barring factor can be configured to always allow access.

### In One Embodiment

Reuse Access Category ‘2’, always skip the bar checking process and access directly. In other words, always skipping a bar checking process and accessing directly, particularly by reusing an access category. There is always a bar checking process before access, that is, this access may be delayed due to the indication of gNB about a normal request. In some scenarios, AC2 can skip bar checking and access directly.

### In One Embodiment

Reuse Access Category ‘8’, using legacy mode to access.

### In One Embodiment

Skip the UAC process and access directly.

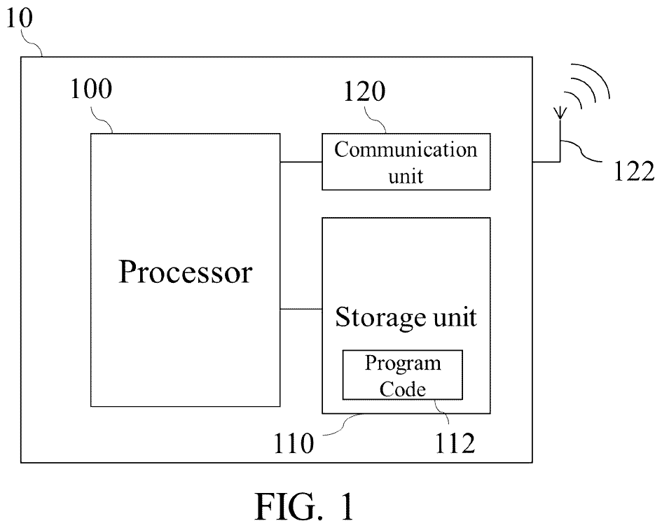

FIG. 1 relates to a schematic diagram of a wireless terminal 10 according to an embodiment of the present disclosure. The wireless terminal 10 may be a user equipment (UE), a mobile phone, a laptop, a tablet computer, an electronic book or a portable computer system and is not limited herein. The wireless terminal 10 may include a processor 100 such as a microprocessor or Application Specific Integrated Circuit (ASIC), a storage unit 110 and a communication unit 120. The storage unit 110 may be any data storage device that stores a program code 112, which is accessed and executed by the processor 100. Embodiments of the storage unit 112 include but are not limited to a subscriber identity module (SIM), read-only memory (ROM), flash memory, random-access memory (RAM), hard-disk, and optical data storage device. The communication unit 120 may a transceiver and is used to transmit and receive signals (e.g. messages or packets) according to processing results of the processor 100. In an embodiment, the communication unit 120 transmits and receives the signals via at least one antenna 122 shown in FIG. 1.

In an embodiment, the storage unit 110 and the program code 112 may be omitted and the processor 100 may include a storage unit with stored program code.

The processor 100 may implement any one of the steps in exemplified embodiments on the wireless terminal 10, e.g., by executing the program code 112.

The communication unit 120 may be a transceiver. The communication unit 120 may as an alternative or in addition be combining a transmitting unit and a receiving unit configured to transmit and to receive, respectively, signals to and from a wireless network node (e.g. a base station).

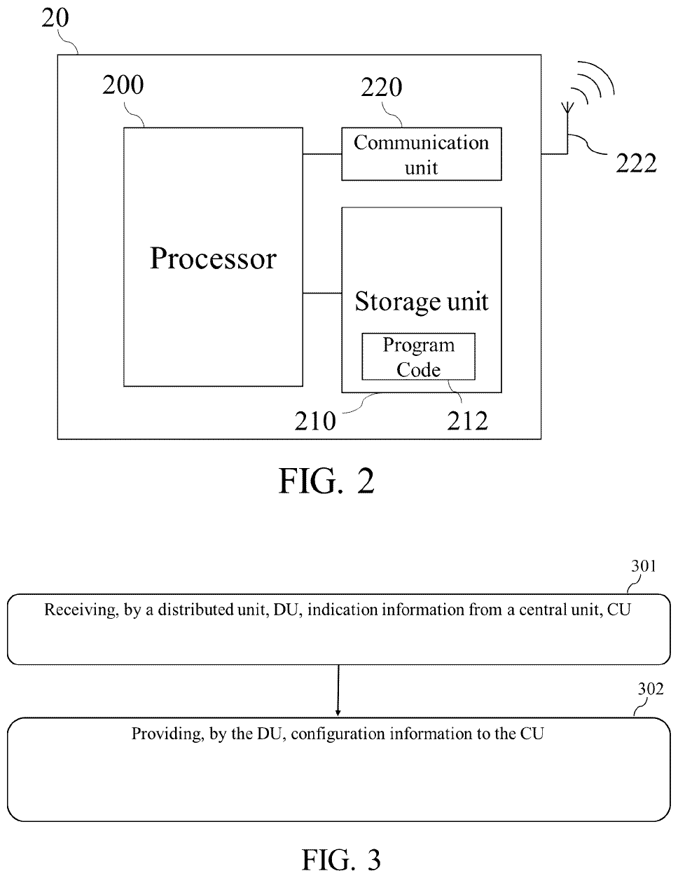

FIG. 2 relates to a schematic diagram of a wireless network node 20 according to an embodiment of the present disclosure. The wireless network node 20 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 20 may comprise (perform) at least one network function such as an access and mobility management function (AMF), a session management function (SMF), a user place function (UPF), a policy control function (PCF), an application function (AF), etc. The wireless network node 20 may include a processor 200 such as a microprocessor or ASIC, a storage unit 210 and a communication unit 220. The storage unit 210 may be any data storage device that stores a program code 212, which is accessed and executed by the processor 200. Examples of the storage unit 212 include but are not limited to a SIM, ROM, flash memory, RAM, hard-disk, and optical data storage device. The communication unit 220 may be a transceiver and is used to transmit and receive signals (e.g. messages or packets) according to processing results of the processor 200. In an example, the communication unit 220 transmits and receives the signals via at least one antenna 222 shown in FIG. 2.

In an embodiment, the storage unit 210 and the program code 212 may be omitted. The processor 200 may include a storage unit with stored program code.

The processor 200 may implement any steps described in exemplified embodiments on the wireless network node 20, e.g., via executing the program code 212.

The communication unit 220 may be a transceiver. The communication unit 220 may as an alternative or in addition be combining a transmitting unit and a receiving unit configured to transmit and to receive, respectively, signals to and from a wireless terminal (e.g. a user equipment or another wireless network node).

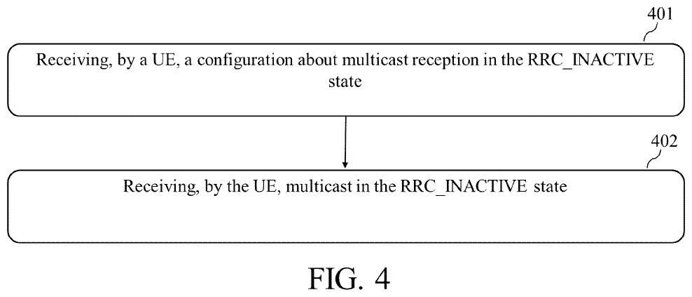

FIG. 3 shows a flowchart of a method according to an embodiment of the present disclosure. In particular, FIG. 3 shows a method for supporting multicast reception for a user equipment, UE, in an RRC_INACTIVE state. The method may be performed by a network node, particularly a distributed unit, DU, which may comprise a processor.

The method comprises receiving 301, by a distributed unit, DU, indication information from a central unit, CU, and providing 302, by the DU, configuration information to the CU.

In an embodiment, the indication information from the CU to the DU is carried in a multicast context setup request and/or a multicast context modification request.

In an embodiment, the indication information from the CU to the DU is carried in a broadcast context setup request and/or a broadcast context modification request.

In an embodiment, the configuration information from the DU to the CU is carried in a multicast context setup response and/or a multicast context modification response.

In an embodiment, the configuration information from the DU to the CU is carried in a broadcast context setup response and/or a broadcast context modification response.

In an embodiment, the indication information from the CU to the DU indicates multicast service(s) is transmitted for the RRC_INACTIVE UE, and/or the DU maintains a point-to-multipoint, PTM, transmission available for multicast service(s) regardless of whether there is a UE in an RRC_CONNECTED state.

In an embodiment, the indication information from the CU to the DU indicates that the DU configures the second set of PTM configuration for the multicast service(s) to be provided by a Multicast and Broadcast Service, MBS, Control Channel, MCCH, and/or the DU configures and provides the second set of PTM configuration for the multicast service(s) to be provided by MCCH.

In an embodiment, the indication information from the CU to the DU indicates that the resources of both sets of PTM configurations for the same multicast service is the same, and/or the DU configures and provides the PTM configuration by the MCCH based on the current PTM configuration provided by dedicated signaling for the same multicast service(s), and/or the CU indicates the resources of two sets of PTM configurations for the same multicast are the same and provides the mapping relationship between the Radio Bearer, RB, index in MCCH and RB ID in dedicated signaling for the same multicast through dedicated signaling.

In an embodiment, the configuration information from DU to CU indicates the resources of both sets of PTM configurations for the same multicast service are the same and/or the CU indicates the resources of two sets of PTM configurations for the same multicast are the same and provides the mapping relationship between the RB index in MCCH and RB ID in dedicated signaling for the same multicast through dedicated signaling.

In an embodiment, the indication information from the CU to the DU indicates that the multicast reception area setting about the multicast service(s) transmitted for the RRC_INACTIVE UE, particularly a RAN-based notification area, RNA area, can be set as a multicast reception area, and/or the DU provides the PTM configuration for the multicast service(s) to all cells in the multicast reception area.

In an embodiment, the information of multicast reception area includes at least one of:
a list of Cell id,
a list of Cell frequency,
a multicast service id, or
whether the PTM configuration is the same or not.

In an embodiment, the indication information from the CU to the DU indicates to request the cell information related to multicast reception for the RRC_INACTIVE UE, and/or the DU provides cell information related to multicast reception to CU.

In an embodiment, the indication information from the CU to the DU carries collected cell information related to multicast reception to the DU.

In an embodiment, the cell information includes at least one of:
a Cell ID,
a Cell frequency,
a multicast service ID transmitted in this cell,
a PTM configuration for multicast transmitted in this cell,
whether to support transmitting multicast to the UE in the RRC_INACTIVE state or not,
whether to deliver the PTM configuration for multicast by MCCH or not, or
whether the cell is congested or not.

FIG. 4 shows a flowchart of a method according to an embodiment of the present disclosure. In particular, FIG. 4 shows a method for supporting multicast reception for a user equipment, UE, in an RRC_INACTIVE state. The method may be performed by a user equipment, UE, which may comprise a processor.

The method comprises receiving 401, by a UE, a configuration about multicast reception in the RRC_INACTIVE state, and receiving 402, by the UE, multicast in the RRC_INACTIVE state.

In an embodiment, the configuration is carried in a Radio Resource Control, RRC, Reconfiguration and/or a RRC Release and/or a Multicast and Broadcast Service, MBS, Control Channel, MCCH.

In an embodiment, the configuration includes an indication information indicating point-to-multipoint, PTM, configuration is provided by a Multicast and Broadcast Service, MBS, control channel, MCCH, for multicast transmitted in the RRC_INACTIVE state.

In an embodiment, the configuration indicates the resources of two PTM configurations for the same multicast are the same, and carries the mapping relationship between the RB index in MCCH and RB ID in dedicated signaling for the same multicast, and/or the UE modifies the MRB ID according to the mapping relationship, and/or the UE receives multicast with the modified MRB.

In an embodiment, the configuration carries a list of neighbor cell information about the multicast reception in the RRC_INACTIVE state.

In an embodiment, the neighbor cell information includes at least one of:
a Cell ID,
a Cell frequency which is providing MBS multicast services, particularly cell defining SSB, CD-SSB,
whether to support transmitting multicast to UE in the RRC_INACTIVE state or not,
whether to deliver the PTM configuration for multicast by MCCH or not,
whether the PTM configuration for the same multicast is the same with the current cell or not, or
whether the cell is congested or not.

In an embodiment, the UE applies the normal cell reselection rules with at least one of the following modifications:
the UE which is receiving or interested to receive MBS service(s) while camping on the frequency providing these MBS service(s) is allowed to make this frequency highest priority,
the UE considers the frequency providing the same PTM configuration about the multicast service(s) which is receiving by UE to be the highest priority,
the UE considers the frequency which is not congested to be the highest priority, or
when the MBS multicast service(s) which the UE is interested in are no longer available, particularly after the end of the session, or the UE is no longer interested in receiving the multicast service(s), the UE no longer prioritises the frequency providing these multicast service(s).

In an embodiment, the neighbor cell information shows PTM configurations in a last serving cell and a re-selected cell are the same, and/or the UE receives multicast using a PTM configuration which is obtained from a last serving cell after cell reselection.

In an embodiment, the neighbor cell information shows PTM configurations in the re-selected cell is delivered by MCCH, and/or the UE monitors the MCCH to obtain a PTM configuration and its update after cell reselection.

In an embodiment, the neighbor cell information shows no congestion and/or no support of MBS service transmission in RRC_INAVTIVE and/or a PTM configuration is not delivered by MCCH in the re-selected cell, and/or the UE triggers a RRC resume procedure after cell reselection.

In an embodiment, when there is no information about a re-selected cell, the method further comprises:
the UE monitoring MCCH to obtain PTM configuration, and, if cannot obtain PTM configuration, the UE triggering the RRC resume procedure, or
the UE triggering a RRC resume procedure to obtain PTM configuration.

In an embodiment, multicast for UEs in an RRC_INACTIVE state further comprises at least one of:
a resumeCause is used for the request of a multicast configuration update, which is carried in an RRC Resume Request,
a resumeCause is used for the request of a multicast service request, which is carried in an RRC Resume Request,
a new access category is added for the request of multicast configuration update/multicast service request, which has a higher priority, and the related barring factor is particularly configured to always allow access,
always skipping a bar checking process and accessing directly, particularly by reusing an access category, or
skipping a unified access control, UAC, process and accessing directly.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A method for supporting multicast reception for a user equipment (UE) in an RRC_INACTIVE state, comprising:
receiving, by a distributed unit (DU) indication information from a central unit (CU), and
providing, by the DU, configuration information to the CU.

2. The method of claim 1, wherein the indication information from the CU to the DU is carried in at least one of: a multicast context setup request or a multicast context modification request.

3. The method of claim 1, wherein the indication information from the CU to the DU is carried in at least one of: a broadcast context setup request or a broadcast context modification request.

4. The method of claim 1, wherein the configuration information from the DU to the CU is carried in at least one of: a multicast context setup response or a multicast context modification response.

5. The method of claim 1, wherein the configuration information from the DU to the CU is carried in at least one of: a broadcast context setup response or a broadcast context modification response.

6. The method of claim 1,
wherein the indication information from the CU to the DU indicates at least one multicast service is transmitted for the RRC_INACTIVE UE, and/or
wherein the DU maintains a point-to-multipoint (PTM) transmission available for at least one multicast service regardless of whether there is a UE in a RRC_CONNECTED connected state;
wherein the indication information from the CU to the DU indicates that the DU configures the second set of PTM configuration for the at least one multicast service to be provided by a Multicast and Broadcast Service (MBS) Control Channel (MCCH), and/or
wherein the DU configures and provides the second set of PTM configuration for the at least one multicast service to be provided by MCCH.

7. The method of claim 6,
wherein the indication information from the CU to the DU indicates that the resources of both sets of PTM configurations for a same multicast service is the same, and/or
wherein the DU configures and provides the PTM configuration by the MCCH based on the current PTM configuration provided by dedicated signaling for the same multicast service, and/or
wherein the CU indicates the resources of two sets of PTM configurations for the same multicast service are the same and provides the mapping relationship between the Radio Bearer (RB) index in MCCH and RB ID in dedicated signaling for the same multicast service through dedicated signaling.

8. The method of claim 6,
wherein the configuration information from DU to CU indicates the resources of both sets of PTM configurations for a same multicast service are the same, and/or
wherein the CU indicates the resources of two sets of PTM configurations for the same multicast service are the same and provides the mapping relationship between the RB index in MCCH and RB ID in dedicated signaling for the same multicast service through dedicated signaling.

9. The method of claim 1,
wherein the indication information from the CU to the DU indicates that the multicast reception area setting about at least one multicast service transmitted for the RRC_INACTIVE UE, particularly a Radio Access Network (RAN)-based notification area (RNA) area, can be set as a multicast reception area, and/or
wherein the DU provides the PTM configuration for the at least one multicast service to all cells in the multicast reception area,
wherein the information of multicast reception area includes at least one of:
a list of Cell id,
a list of Cell frequency,
a multicast service id, or
whether the PTM configuration is the same or not.

10. The method of claim 1,
wherein the indication information from the CU to the DU indicates to request the cell information related to multicast reception for the RRC_INACTIVE UE, and/or
wherein the DU provides cell information related to multicast reception to CU,
wherein the indication information from the CU to the DU carries collected cell information related to multicast reception to the DU,
wherein the cell information includes at least one of:
a Cell ID,
a Cell frequency,
a multicast service ID transmitted in this cell,
a PTM configuration for multicast transmitted in this cell,
whether to support transmitting multicast to the UE in the RRC_INACTIVE state or not,
whether to deliver the PTM configuration for multicast by MCCH or not, or
whether the cell is congested or not.

11. A network node supporting multicast reception for a user equipment (UE) in an RRC_INACTIVE state comprising a processor configured to:
receive, via a transceiver, indication information from a central unit (CU), and
provide, via the transceiver, configuration information to the CU.

12. The network node of claim 11, wherein the indication information from the CU to the network node is carried in at least one of: a multicast context setup request or a multicast context modification request.

13. The network node of claim 11, wherein the indication information from the CU to the network node is carried in at least one of: a broadcast context setup request or a broadcast context modification request.

14. The network node of claim 11, wherein the configuration information from the network node to the CU is carried in at least one of: a multicast context setup response or a multicast context modification response.

15. The network node of claim 11, wherein the configuration information from the network node to the CU is carried in a broadcast context setup response or a broadcast context modification response.

16. The network node of claim 11,
wherein the indication information from the CU to the network node indicates at least one multicast service is transmitted for the RRC_INACTIVE UE, and/or
wherein the processor of the network node is configured to keep a point-to-multipoint (PTM) transmission available for at least one multicast service regardless of whether there is a UE in a RRC_CONNECTED state,
wherein the indication information from the CU to the network node indicates that the processor of the network node is configured to configure the second set of PTM configuration for the at least one multicast service to be provided by a Multicast and Broadcast Service (MBS) control channel (MCCH), and/or
wherein the processor of the network node is configured to configure and provide the second set of PTM configuration for the at least one multicast service to be provided by MCCH.

17. The network node of claim 16,
wherein the indication information from the CU to the network node indicates that the resources of both sets of PTM configurations for a same multicast service is the same, and/or
wherein the processor of the network node is configured to configure and provide the PTM configuration by the MCCH based on the current PTM configuration provided by dedicated signaling for the same multicast service, and/or
wherein the CU is configured to indicate the resources of two sets of PTM configurations for the same multicast service are the same and to provide the mapping relationship between the RB index in MCCH and RB ID in dedicated signaling for the same multicast service through dedicated signaling.

18. The network node of claim 11,
wherein the indication information from the CU to the network node indicates that the multicast reception area setting about at least one multicast service transmitted for the RRC_INACTIVE UE, particularly a RAN-based notification area (RNA) area, can be set as a multicast reception area, and/or
wherein the processor of the network node is configured to provide the PTM configuration for the at least one multicast service to all cells in the multicast reception area, wherein the information of multicast reception area includes at least one of:
a list of Cell id,
a list of Cell frequency,
a multicast service id, or
whether the PTM configuration is the same or not.

19. The network node of claim 11,
wherein the indication information from the CU to the network node indicates to request the cell information related to multicast reception for the RRC_INACTIVE UE, and/or
wherein the processor of the network node is configured to provide cell information related to multicast reception to CU,
wherein the indication information from the CU to the network node carries collected cell information related to multicast reception to the network node,
wherein the cell information includes at least one of:
a Cell ID,
a Cell frequency,
a multicast service ID transmitted in this cell,
a PTM configuration for multicast transmitted in this cell,
whether to support transmitting multicast to the UE in the RRC_INACTIVE state or not,
whether to deliver the PTM configuration for multicast by MCCH or not, or
whether the cell is congested or not.

20. A non-transitory computer-readable program medium with code stored thereupon, the code, when executed by at least one processor, causes the at least one processor to implement a wireless communication method recited in claim 1.
